(19) United States
(12) Patent Application Publication
(10) Pub. No.: US 2014/0184375 A1
(43) Pub. Date: Jul. 3, 2014

(54) REACTOR

(71) Applicants: Takahito Murata, Toyokawa-shi (JP); Kenji Kiriyama, Miyoshi-shi (JP); Yoshihiro Yamaguchi, Toyota-shi (JP)

(72) Inventors: Takahito Murata, Toyokawa-shi (JP); Kenji Kiriyama, Miyoshi-shi (JP); Yoshihiro Yamaguchi, Toyota-shi (JP)

(73) Assignee: TOYOTA JIDOSHA KABUSHIKI KAISHA, Toyota-shi, Aichi-ken (JP)

(21) Appl. No.: 14/232,516

(22) PCT Filed: Jul. 20, 2011
(86) PCT No.: PCT/JP2011/066428

§ 371 Date: Jan. 13, 2014

(51) Int. Cl. H01F 27/28

(52) U.S. Cl. CPC H01F 27/28
USPC 336/196

(57) ABSTRACT

A reactor includes a core body having a U-shape block core and an I-shape block core arranged with a gap, a coil wound on an outer circumference of the core body, and a gap plate inserted into the gap between the U-shape block core and I-shape block core. The gap plate includes a coil retaining member extending towards and retaining the coil. By such a configuration, a reactor having temperature increase at the coil suppressed can be provided.

### TECHNICAL FIELD

The present invention generally relates to a reactor, more particularly, to a reactor mounted on a vehicle, and employed in a converter to step up and down a voltage for vehicle traction.

### BACKGROUND ART

As a conventional reactor, Japanese Patent Laying-Open No. 2006-351920, for example, discloses a reactor having a through hole to constitute a gap formed in the core, directed to solving the problem of generated heat concentration without adversely affecting the rigidity of the core (PTD 1). In the reactor disclosed in PTD 1, a plurality of through holes constituting a gap are formed at an I type block core around which a coil is wound.

Further, Japanese Patent Laying-Open No. 2010-103307 discloses a reactor directed to facilitating the coupling between an insulator and a magnetic core, reducing the joining face temperature at the time of reactor operation as much as possible, and ensuring the initial magnetic path length and inductance performance entirely over a period starting from the joining between the insulator and magnetic core up to reactor operation (PTD 2). In the reactor disclosed in PTD 2, a plurality of magnetic cores are joined via an insulator. The insulator includes a non-magnetic gap plate, and a non-magnetic resin sheet provided at both sides of the gap sheet.

Japanese Patent Laying-Open No. 2003-51414 discloses an electromechanical device directed to keeping the gap constant in a resin mold sealing electromechanical device during the resin mold formation (PTD 3). In the electromechanical device disclosed in PTD 3, an insulation member having a plurality of insulation projections formed is attached to a portion of the outer circumference of a layered electromagnetic steel sheet that is an iron core that can be segmented. Around the outer circumference of the insulation member, a coil formed of a spiral-wound steel plate is attached so as to be fitted into the space between the plurality of insulation projections.

Japanese Patent Laying-Open No. 2008-28313 discloses a reactor directed to improving the heat radiating effect from the core to a case or the like by sufficient transmission of the heat generated at the coil (PTD 4). In the reactor disclosed in PTD 4, a bobbin formed of a metal material is provided between an annular core and a coil provided on the outer circumference of the core. An insulation coat film is provided on the surface of the bobbin.

Japanese Patent Laying-Open No. 2002-217040 discloses a stationary induction electrical device such as a reactor directed to providing a compact inductor having the cooling efficiency of an iron core, particularly the iron core around which a coil is wound in the stationary induction electrical device, improved (PTD 5). In the stationary induction electrical device disclosed in PTD 5, a thermal-conductive plate with a plurality of fins in the axial direction of the coil is provided at both outer side ends of an iron core around which a coil is wound.

Japanese Patent Laying-Open No. 11-288819 discloses a transformer and reactor directed to maintaining the same performance characteristics with high heat radiating efficiency while achieving reduction in size (PTD 6). Further, Japanese Patent Laying-Open No. 2009-33057 discloses a core for a reactor, directed to reducing flux leakage (PTD 7).

### CITATION LIST

### Patent Document

PTD 1: Japanese Patent Laying-Open No. 2006-351920

PTD 2: Japanese Patent Laying-Open No. 2010-103307

PTD 3: Japanese Patent Laying-Open No. 2003-51414

PTD 4: Japanese Patent Laying-Open No. 2008-28313

PTD 5: Japanese Patent Laying-Open No. 2002-217040

PTD 6: Japanese Patent Laying-Open No. 11-288819

PTD 7: Japanese Patent Laying-Open No. 2009-33057

### SUMMARY OF INVENTION

### Technical Problem

Great attention is focused on hybrid vehicles and electric vehicles in consideration of the growing awareness of saving energy and environmental problems. For example, a hybrid vehicle includes, as the power source, a motor to which electric power is supplied from a DC power supply, in addition to a conventional engine. In other words, a power source is achieved by driving the engine, and also by converting the DC voltage from a DC power supply into AC voltage by an inverter, and using the converted AC voltage to rotate the motor.

A hybrid vehicle is mounted with a converter to step up and down DC current between a DC power supply and an inverter. For the converter, a reactor is employed, including a core body having a plurality of core sections arranged with a gap (clearance), and a coil wound around the core body. When flux leakage occurs at the gap between the core sections in a reactor of the aforementioned configuration, eddy current is generated at the site where the flux leakage establishes interlinkage with the coil, causing heat to be generated locally at the coil. In this case, the temperature rise at the coil may induce degradation of the converter performance.

In view of the foregoing, an object of the present invention is to provide a reactor having temperature increase at the coil suppressed.

### Solution to Problem

A reactor according to the present invention includes a core body having a first core section and a second core section arranged with a gap, a coil wound on an outer circumference of the core body, and a first spacer inserted into the gap between the first core section and the second core section. The first spacer includes a first retaining member extending towards and retaining the coil.

According to the reactor of the aforementioned configuration, the first retaining member for retaining the coil is provided at the first spacer inserted in the gap between the first core section and the second core section. Therefore, even in the case where heat is generated locally at the coil due to flux leakage occurring at the gap between the first core section and the second core section, the heat is transmitted through the first spacer to the core body to be released. Thus, the temperature increase at the coil can be suppressed.

Preferably, the core body further includes a third core section located at a side opposite to the first core section relative to the second core section, and having a gap from the second core section. The reactor further includes a second spacer inserted in the gap between the second core section and the third core section. The second spacer includes a second retaining member extending towards and retaining the coil. The coil is wound on the outer circumference of the second core section, and sandwiched between the first retaining member and the second retaining member.

According to the reactor configured as set forth above, the heat generated at the coil is transmitted through the first and second spacers to the core body to be released. Therefore, the temperature increase at the coil can be suppressed more effectively.

Further preferably, the coil is sandwiched between the first retaining member and second retaining member in a compression-deformed state in a direction in which the second core section extends, between the first core section and third core section. According to the reactor configured as set forth above, the coil can be retained more reliably by the first retaining member and second retaining member.

Further preferably, the first spacer further includes a positioning member extending towards the first core section and the second core section, and regulating the relative position of the first core section and the second core section. According to the reactor configured as set forth above, the provision of a positioning member at the first spacer to regulate the relative position of the first core section and second core section allows the first core section and second core section to be positioned accurately.

More preferably, on the outer circumference of the gap between the first core section and the second core section, the coil is not arranged, and the first retaining member is arranged. According to the reactor configured as set forth above, the amount of flux leakage establishing interlinkage with the coil can be reduced, as compared to the case where a coil is arranged on the outer circumference of the gap between the first core section and the second core section. Accordingly, generation of heat at the coil can be suppressed.

Further preferably, the first spacer is formed integrally of a non-magnetic material. According to a reactor configured as set forth above, the temperature increase at the coil can be suppressed by a simple configuration.

Further preferably, the core body is formed by a dust core. According to a reactor of a configuration set forth above, the temperature increase at the coil can be suppressed by modifying the configuration of the first spacer, not the core body of low strength formed by a dust core.

### Advantageous Effects of Invention

According to the present invention, a reactor having the temperature increase at the coil suppressed can be provided.

### BRIEF DESCRIPTION OF DRAWINGS

FIG. 1 schematically represents a driving unit of a hybrid vehicle.

FIG. 2 is an electric circuit diagram representing a configuration of the PCU in FIG. 1.

FIG. 3 is a sectional view of a reactor constituting the converter in FIG. 2.

FIG. 4 is a perspective view of a gap plate provided at the reactor in FIG. 3.

FIG. 5 is another perspective view of a gap plate provided at the reactor in FIG. 3.

### DESCRIPTION OF EMBODIMENTS

Embodiments of the present invention will be described hereinafter with reference to the drawings. In the drawings, the same or corresponding elements have the same reference characters allotted.

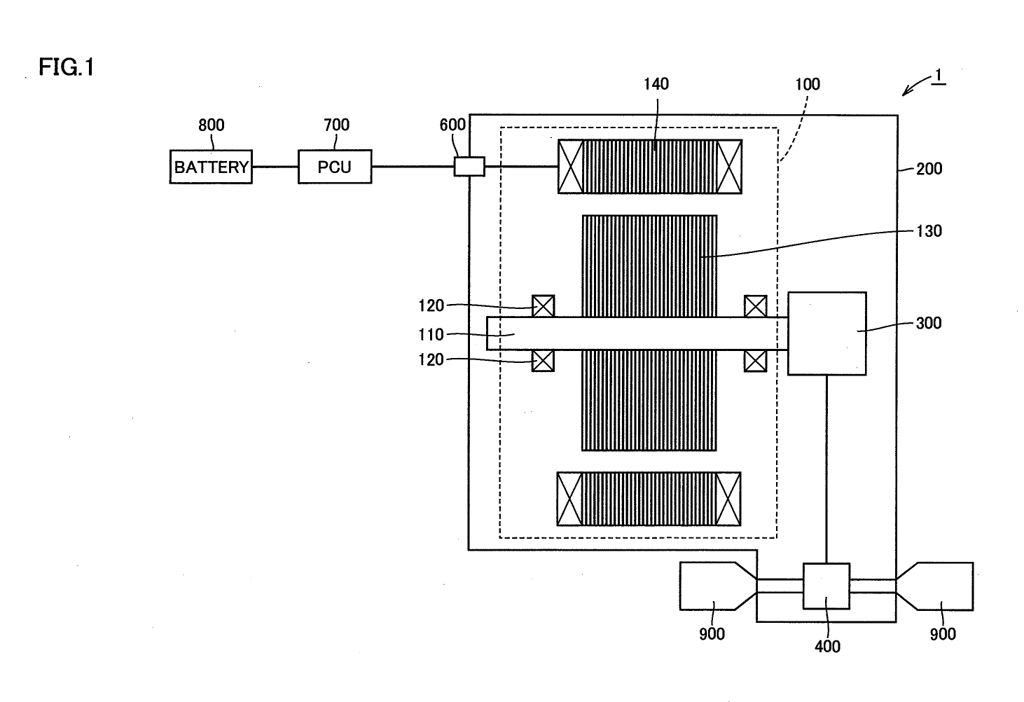

FIG. 1 schematically represents a driving unit of a hybrid vehicle. In the present embodiment, a reactor according to the present invention is applied to a converter mounted on a hybrid vehicle that is one type of a vehicle. First, an HV system to drive a hybrid vehicle will be described.

Referring to FIG. 1, a driving unit 1 is provided at a hybrid vehicle including an internal combustion engine such as a gasoline engine or diesel engine, and a rechargeable battery 800 as the power source. Driving unit 1 includes a motor generator 100, a housing 200, a gear reduction mechanism 300, a differential mechanism 400, a drive shaft receiver 900, and a terminal base 600.

Motor generator 100 is a rotating electric machine functioning as an electric motor or a power generator. Motor generator 100 includes a rotational shaft 110, a rotor 130, and a stator 140. Rotational shaft 110 is rotatably attached to a housing 200 via a bearing 120. Rotor 130 rotates integrally with rotational shaft 110.

The power output from motor generator 100 is transmitted from gear reduction mechanism 300 to drive shaft receiver 900 via differential mechanism 400. The driving power transmitted to drive shaft receiver 900 is transmitted to the wheel as a turning force via the drive shaft to cause the vehicle to run.

In a regenerative braking mode of the hybrid vehicle, the wheel is rotated by the inertial of the vehicle body. The turning force from the wheel causes motor generator 100 to be driven via drive shaft receiver 900, differential mechanism 400 and gear reduction mechanism 300. At this stage, motor generator 100 operates as a power generator. The electric power generated by motor generator 100 is supplied to a battery 800 via a PCU (Power Control Unit) 700.

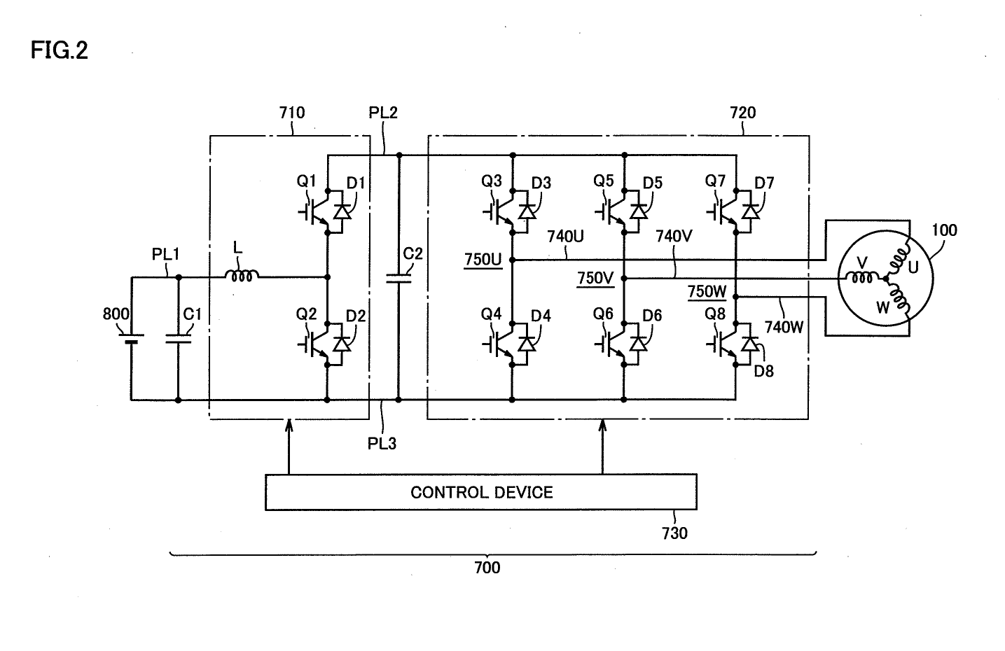

FIG. 2 is an electric circuit diagram of a configuration of the PCU in FIG. 1. Referring to FIG. 2, PCU 700 includes a converter 710, an inverter 720, a control device 730, capacitors C1 and C2, power supply lines PL1-PL3, and output lines 740U, 740V and 740W.

Converter 710 is connected to battery 800 via power supply lines PL1 and PL3. Inverter 720 is connected to converter 710 via power supply lines PL2 and PL3. Inverter 720 is connected to motor generator 100 via output lines 740U, 740V and 740W. Battery 800 is a DC power supply, constituted of a secondary battery such as nickel-metal hydride battery, lithium ion battery, or the like. Battery 800 supplies its stored DC power to converter 710, and is charged by the DC power received from converter 710.

Converter 710 includes an upper arm and a lower arm consisting of a semiconductor module, and a reactor L. The upper and lower arms are connected in series between power supply lines PL2 and PL3. The upper arm connected to power supply line PL2 includes a power transistor (IGBT: Insulated Gate Bipolar Transistor) Q1, and a diode D1 antiparallel-connected to power transistor Q1. The lower arm connected to power supply line PL3 includes a power transistor Q2, and a diode D2 antiparallel-connected to power transistor Q2. Reactor L is connected between power supply line PL1 and the connection node of the upper arm and lower arm.

Converter 710 steps up the DC voltage received from battery 800 using reactor L to supply the boosted voltage onto power supply line PL2. Converter 710 steps down the DC voltage received from inverter 720 to charge battery 800.

Inverter 720 includes a U-phase arm 750U, a V-phase arm 750V, and a W-phase arm 750W. U-phase arm 750U, V-phase arm 750V and W-phase arm 750W are connected in parallel between power supply lines PL2 and PL3. The upper arm and lower arm consisting of a semiconductor module constitute each of U-phase arm 750U, V-phase arm 750V and W-phase arm 750W. The upper arm and lower arm of each phase arm are connected in series between power supply lines PL2 and PL3.

The upper arm of U-phase arm 750U includes a power transistor (IGBT) Q3, and a diode D3 antiparallel-connected to power transistor Q3. The lower arm of U-phase arm 750U includes a power transistor Q4 and a diode D4 antiparallel-connected to power transistor Q4. The upper arm of V-phase arm 750V includes a power transistor Q5 and a diode D5 antiparallel-connected to power transistor Q5. The lower arm of V-phase arm 750V includes a power transistor Q6 and a diode D6 antiparallel-connected to power transistor Q6. The upper arm of W-phase arm 750W includes a power transistor Q7 and a diode D7 antiparallel-connected to power transistor Q7. The lower arm of W-phase arm 750W includes a power transistor Q8 and a diode D8 antiparallel-connected to power transistor Q8. The connection node of the power transistors of each phase arm is connected to the anti-neutral point of the coil in the corresponding phase of motor generator 100 via corresponding output lines 740U, 740V and 740W.

Although the drawing shows the upper and lower arms of U-phase arm 750U to W-phase arm 750W constituted of one semiconductor module including a power transistor and a diode, each of the upper and lower arms may be constituted of a plurality of semiconductor modules.

Inverter 720 converts DC voltage received from power supply line PL2 into AC voltage for output to motor generator 100 based on a control signal from control device 730. Inverter 720 rectifies AC voltage generated by motor generator 100 to DC voltage for supply onto power supply line PL2.

Capacitor C1 is connected between power supply lines PL1 and PL3 to smooth the voltage level of power supply line PL1. Capacitor C2 is connected between power supply lines PL2 and PL3 to smooth the voltage level of power supply line PL2.

Control device 730 computes the coil voltage of each phase of motor generator 100 based on a torque command value of motor generator 100, each phase current value, and input voltage of inverter 720. Based on the computed result, control device 730 generates and outputs to inverter 720 a PWM (Pulse Width Modulation) signal directed to turning ON/OFF power transistors Q3-Q8. Each phase current value of motor generator 100 is detected by a current sensor incorporated in a semiconductor module constituting each arm of inverter 720. This current sensor is arranged in a semiconductor module to improve the S/N ratio. Control device 730 calculates the duty ratio of power transistors Q1 and Q2 to optimize the input voltage to inverter 720 based on the aforementioned torque command value and motor revolution speed. Control device 730 generates and outputs to converter 710 a PWM signal directed to turning ON/OFF power transistors Q1 and Q2, based on the result.

Control device 730 controls the switching operation of power transistors Q1-Q8 in converter 710 and inverter 720 to convert AC voltage generated by motor generator 100 into DC voltage to charge battery 800.

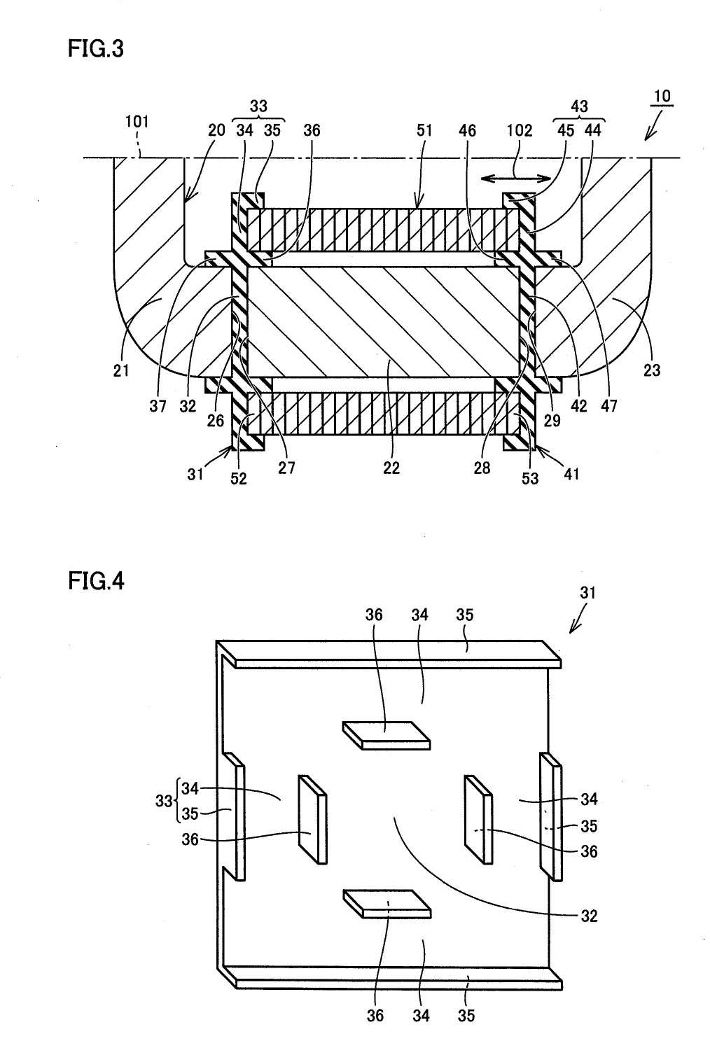

A configuration of a reactor according to the present embodiment will be described hereinafter. FIG. 3 is a sectional view representing a reactor constituting the converter in FIG. 2.

Referring to FIG. 3, reactor 10 of the present embodiment includes a core body 20, a coil 51, and gap plates 31 and 41. Reactor 10 has a symmetric configuration about a center line 101. The sectional configuration of reactor 10 arranged at one side relative to center line 101 is shown in the drawing.

Core body 20 has a configuration extending annularly as a whole. Core body 20 has a track shape based on a combination of a linear section and a curving section. In the present embodiment, core body 20 is formed of a compact of magnetic powder, i.e. dust core. Core body 20 may be formed of a stack of silicon steel sheets superior in electromagnetic property.

Core body 20 is accommodated in a casing not shown, for example, an aluminum-made case. The casing is filled with a potting agent (resin) so as to cover core body 20 entirely. The potting agent is provided by pouring resin of low viscosity into the casing in which core body 20, coil 51, and gap plates 31 and 41 are placed, and, thermal curing the resin at the next step.

The configuration of core body 20 will be described more specifically. Core body 20 includes a U-shape block core 21, an I-shape block core 22, and a U-shape block core 23. I-shape block core 22 has a linear elongated shape. I-shape block core 22 extends in one direction indicated by arrow 102 (direction parallel to center line 101). U-shape block core 21 and U-shape block core 23 are formed including a curving extending section. U-shape block core 21 and U-shape block core 23 have the same shape.

U-shape block core 21 and I-shape block core 22 are arranged with a gap (clearance) therebetween. U-shape block core 21 has an end face 26, whereas I-shape block core 22 has an end face 27 facing end face 26 with a gap therebetween. I-shape block core 22 and U-shape block core 23 are arranged with a gap therebetween. U-shape block core 23 is arranged at the opposite side of U-shape block core 21 relative to I-shape block core 22. U-shape block core 23 has an end face 29, whereas I-shape block core 22 has an end face 28 facing end face 29 with a gap therebetween. U-shape block core 21, I-shape block core 22 and U-shape block core 23 are aligned in the direction shown by arrow 102 with a gap between block cores arranged adjacent to each other.

The drawing shows a configuration in which one I-shape block core 22 is arranged between U-shape block core 21 and U-shape block core 23. However, core body 20 is not limited to such a configuration. The gap thickness between the cores is a design requirement to meet the electrical performance (inductance value) of the reactor. How the required gap thickness is provided (2 gaps, 4 gaps, 6 gaps . . . ) is determined appropriately taking into account the thermal performance condition, fabrication constraints, cost restriction and the like.

Coil 51 is wound on the outer circumference of core body 20. Coil 51 is wound on the outer circumference of I-shape block core 22. Coil 51 is formed by a long steel sheet spirally wound on the outer circumference of I-shape block core 22. Coil 51 runs in a series of cyclical movements along the outer circumference of I-shape block core 22 to extend in the direction indicated by arrow 102. Coil 51 has one end 52 located at the extremity in the direction approaching U-shape block core 21 from U-shape block core 23, and the other end 53 located at the extremity in the direction approaching U-shape block core 23 from U-shape block core 21.

In the present embodiment, coil 51 is arranged between an end face 27 and an end face 28 of I-shape block core 22 in the direction indicated by arrow 102. In other words, coil 51 is not arranged on the outer circumference of the gap between U-shape block core 21 and I-shape block core 22, and on the outer circumference of the gap between I-shape block core 22 and U-shape block core 23.

DC current flow through coil 51 causes generation of a magnetic flux inside I-shape block core 22. The magnetic flux circulates inside annular core body 20.

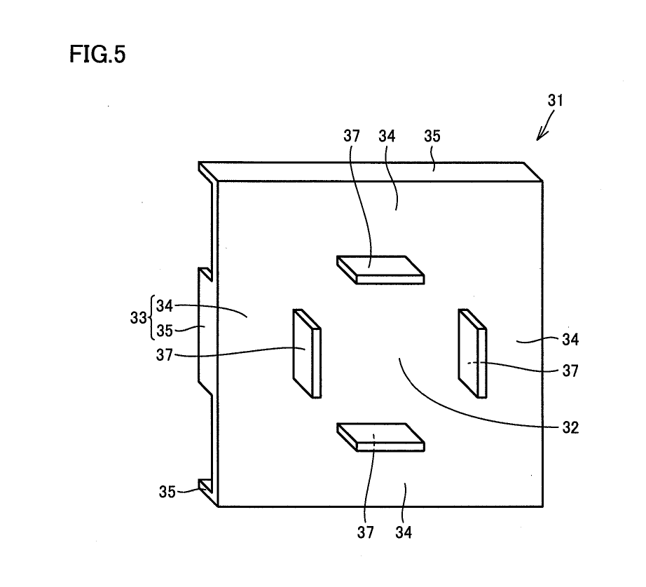

FIG. 4 is a perspective view representing gap plates provided at the reactor in FIG. 3. FIG. 5 is another perspective view representing gap plates provided at the reactor in FIG. 3.

Referring to FIGS. 3-5, gap plate 31 is formed of a non-magnetic material. Gap plate 31 is formed of a material having a hardness that is not displaced by the attraction caused by change in the magnetic field. Gap plate 31 is formed of a material having high thermal conductance. In the present embodiment, gap plate 31 is formed of a ceramic material. Gap plate 31 is provided as a spacer arranged at the gap between U-shape block core 21 and I-shape block core 22. Gap plate 31 is provided so as to form contact with U-shape block core 21 and I-shape block core 22, and with coil 51.

The configuration of gap plate 31 will be described more specifically. Gap plate 31 includes a plate member 32, a coil retaining member 33, and core positioning members 36 and 37. These members are formed integrally by a non-magnetic material.

Plate member 32 has a board shape. In plan view, plate member 32 has the same shape (rectangular shape) as end face 26 of U-shape block core 21 and end face 27 of I-shape block core 22. Plate member 32 is arranged at the gap between U-shape block core 21 and I-shape block core 22. The thickness of plate member 32 has the dimension and dimension accuracy to satisfy the electrical property (inductance value) of the reactor.

Plate member 32 joins end face 26 of U-shape block core 21 and end face 27 of I-shape block core 22 by means of an adhesive (not shown) having high hardness when hardened.

Coil retaining member 33 extends from plate member 32 towards coil 51. Coil retaining member 33 has a shape that allows coil 51 to be retained.

More specifically, coil retaining member 33 is formed by a flange 34 and a catch 35. Flange 34 is formed extending from the outer boundary of plate member 32 in a peripheral manner. Flange 34 abuts against one end 52 of coil 51. Catch 35 is bent from the outer edge of flange 34 in a direction approaching U-shape block core 23 from U-shape block core 21. Catch 35 is arranged so as to surround the outer circumference of coil 51. Coil 51 is fitted at the inner side of catch 35 to be retained.

Catch 35 may take a columnar shape so as to surround the overall circumference of coil 51, or may take an incomplete columnar shape, as shown in FIG. 4.

Core positioning member 36 is formed protruding from the boundary location between plate member 32 and flange 34 in a direction approaching U-shape block core 23 from U-shape block core 21. Core positioning member 36 is arranged to surround the outer circumference of I-shape block core 22. Core positioning member 37 is formed protruding from the boundary location between plate member 32 and flange 34 in a direction approaching U-shape block core 21 from U-shape block core 23. Core positioning member 37 is arranged to surround the outer circumference of U-shape block core 21. Core positioning member 37 is located at the back side of core positioning member 36 with plate member 32 and flange 34 therebetween.

I-shape block core 22 is fitted at the inner side of core positioning member 36, whereas U-shape block core 21 is fitted at the inner side of core positioning member 37. By such a configuration, the relative position of U-shape block core 21 and I-shape block core 22 joined with gap plate 31 therebetween is regulated by core positioning member 36 and core positioning member 37.

The fitting of U-shape block core 21 and I-shape block core 22 with core positioning members 36 and 37 does not have to be in close-fitting as long as these core blocks can be positioned within the tolerable range in design.

Gap plate 41 has a configuration basically similar to that of gap plate 31. The configuration of gap plate 41 will be described hereinafter while avoiding duplicating description with gap plate 31. Gap plate 31 is provided as a spacer arranged at the gap between I-shape block core 22 and U-shape block core 23. Gap plate 41 is provided so as to form contact with I-shape block core 22 and U-shape block core 23 as well as with coil 51.

Gap plate 41 includes a plate member 42 corresponding to plate member 32 of gap plate 31, a coil retaining member 43 corresponding to coil retaining member 33, and a core positioning member 46 and a core positioning member 47 corresponding to core positioning member 36 and core positioning member 37, respectively.

Plate member 42 has the same shape as end face 28 of I-shape block core 22 and end face 29 of U-shape block core 23 in plan view. Plate member 42 is arranged at the gap between I-shape block core 22 and U-shape block core 23. Plate member 42 joins end face 28 of 1-shape block core 22 and end face 29 of U-shape block core 23 by means of an adhesive having high hardness when hardened.

Coil retaining member 43 is formed by a flange 44 and a catch 45. Flange 44 is formed extending from the outer boundary of plate member 42 in a peripheral manner. Flange 44 abuts against the other end 53 of coil 51. Catch 45 is bent from the outer edge of flange 44 in a direction approaching U-shape block core 21 from U-shape block core 23. Catch 45 is arranged so as to surround the outer circumference of coil 51. Coil 51 is fitted at the inner side of catch 45 to be retained.

By such a configuration, the position of coil 51 in the orthogonal plane in the direction indicated by arrow 102 is secured by catches 35 and 45, and coil 51 is sandwiched between coil retaining member 33 and coil retaining member 43 in the direction indicated by arrow 102.

The distance between coil retaining member 33 and coil retaining member 43 is less than or equal to a value that can regulate the movement of coil 51 in the stretching direction of coil 51 caused by the spring force subsequent to winding, and less than or equal to a value at which the coil is not displaced by influence of vehicle vibration. The distance between coil retaining member 33 and coil retaining member 43 is greater than the minimum dimension when coil 51 is compression-deformed.

Core positioning member 46 is formed protruding from the boundary location between plate member 42 and flange 44 in a direction approaching U-shape block core 21 from U-shape block core 23. Core positioning member 46 is arranged so as to surround the outer circumference of I-shape block core 22. Core positioning member 47 is formed protruding from the boundary location between plate member 42 and flange 44 in a direction approaching U-shape block core 23 from U-shape block core 21. Core positioning member 47 is arranged to surround the outer circumference of U-shape block core 21. Core positioning member 47 is located at the back side of core positioning member 46 with plate member 42 and flange 44 therebetween.

I-shape block core 22 is fitted at the inner side of core positioning member 46. U-shape block core 23 is fitted at the inner side of core positioning member 47. By such a configuration, the relative position of I-shape block core 22 and U-shape block core 23 located at both sides and joined with gap plate 41 therebetween is regulated by core positioning member 46 and core positioning member 47.

The advantageous effect provided by reactor 10 of the present embodiment will be described hereinafter.

In accordance with the circulation of the magnetic flux in the annular core body 20 at the time of current supply to coil 51, flux leakage occurs at the gap between U-shape block core 21 and I-shape block core 22 and between I-shape block core 22 and U-shape block core 23. This flux leakage causes eddy current at the site establishing interlinkage with coil 51, leading to generation of heat locally at coil 51.

At reactor 10 according to the present embodiment, a coil retaining member 33 for retaining coil 51 is provided at gap plate 31 inserted into the gap between U-shape block core 21 and I-shape block core 22, and a coil retaining member 43 for retaining coil 51 is provided at gap plate 41 inserted into the gap between I-shape block core 22 and U-shape block core 23. By such a configuration, the heat generated at coil 51 is transmitted to core body 20 through gap plate 31 and gap plate 41, allowing heat to be released effectively through the casing in contact with core body 20. As a result, temperature increase at coil 51 can be suppressed.

In the present embodiment, a constraint is imposed when core body 20 is to be modified in shape since core body 20 is formed of dust core, low in strength. Although the usage of material differing in relative permeability for a portion of core body 20 may be considered as a measure to suppress temperature increase at coil 51, this approach will induce the problem of increasing the fabrication cost. Such a problem can be overcome in the case where a releasing path for the heat generated at coil 51 is to be provided by modifying the shape of gap plates 31 and 41 inserted into the gap between block cores,. Moreover, since coil 51 is not arranged on the outer circumference of the gap between U-shape block core 21 and I-shape block core 22 and on the other circumference of the gap between I-shape block core 22 and U-shape block core 23 in the present embodiment, the advantage of reducing to some degree the flux leakage interlinked with coil 51 can be achieved.

Although the present embodiment has been described based on a configuration in which the casing where core body 20 is stored is filled with a potting agent, a configuration in which the reactor does not use a potting agent may be employed. In the case where the reactor does not use a potting agent, there may a problem that the vibration occurring during a running operation of the hybrid vehicle will be transmitted to coil 51 to cause vibration thereat. However, since coil 51 is retained by gap plates 31 and 41 in the present embodiment, vibration of coil 51 can be suppressed. Here, vibration of coil 51 can be prevented more reliably by arranging coil 51 in a compression-deformed state between gap plate 31 and gap plate 41.

The configuration of the reactor according to an embodiment of the present invention set forth above is summarized as follows. Reactor 10 of the present embodiment includes a core body 20 having U-shape block core 21 as the first core section and an I-shape block core 22 as the second core section arranged with a gap, a coil 51 wound on the outer circumference of core body 20, and a gap plate 31 as the first spacer inserted into the gap between U-shape block core 21 and I-shape block core 22. Gap plate 31 includes coil retaining member 33 qualified as the first retaining member, extending towards and retaining coil 51.

Core body 20 further includes U-shape block core 23 located at the side opposite to U-shape block core 21 relative to I-shape block core 22, qualified as the third core section arranged with a gap from I-shape block core 22. Reactor 10 further includes gap plate 41 as the second spacer inserted into the gap between I-shape block core 22 and U-shape block core 23. Gap plate 41 includes a coil retaining member 43 qualified as the second retaining member extending towards and retaining coil 51. Coil 51 is wound on the outer circumference of I-shape block core 22, sandwiched between coil retaining member 33 and coil retaining member 43.

According to reactor 10 configured as set forth above in an embodiment of the present invention, the provision of coil retaining members 33 and 43 for retaining coil 51 at gap plates 31 and 41 allows the temperature increase at coil 51 to be suppressed. Accordingly, the range that can maintain the operating point of PCU 700 at the optimum region is increased, which in turn contributes to the running capability performance and fuel usage of the hybrid vehicle. Further, the reactor can be rendered compact by reducing the cross sectional area of coil 51 and the required amount of a potting agent for heat radiation can be reduced. Moreover, by suppressing temperature increase at the joining site of gap plates 31 and 41 with core body 20, the reliability of the gap section of core body 20 (durability) can be improved.

The present invention can also be applied to a reactor mounted on a fuel cell hybrid vehicle (FCHV) with a fuel cell and secondary cell as the power source, or an electric vehicle (EV). A hybrid vehicle according to the present embodiment has the internal combustion engine driven at the fuel consumption optimum operating point, whereas a fuel cell hybrid vehicle has the fuel cell driven at the power generation efficiency optimum operating point. The usage of a secondary battery is basically similar to that for both hybrid vehicles set forth above.

It should be understood that the embodiments disclosed herein are illustrative and nonrestrictive in every respect. The scope of the present invention is defined by the terms of the claims, rather than the description set forth above, and is intended to include any modifications within the scope and meaning equivalent to the terms of the claims.

### INDUSTRIAL APPLICABILITY

The present invention is applied to, for example, a converter that steps up and down DC current between a DC power supply and an inverter.

### REFERENCE SIGNS LIST

1 driving unit; 10 reactor; 20 core body; 21, 23 U-shape block core; 22 I-shape block core; 26-29 end face; 31, 41 gap plate; 32, 42 plate member; 33, 43 coil retaining member; 34, 44 flange; 35, 45 catch; 36, 37, 46, 47 core positioning member; 51 coil; 52 one end; 53 other end; 100 motor generator; 110 rotational shaft; 120 bearing; 130 rotor; 140 stator; 200 housing; 300 gear reduction mechanism; 400 differential mechanism; 600 terminal block; 710 converter; 720 inverter; 730 control device; 740U, 740V, 740W output lines; 750U U-phase arm; 750V V-phase arm; 750W W-phase arm; 800 battery; 900 drive shaft receiver.

1. A reactor comprising:
a core body including a first core section and a second core section arranged with a gap,
a coil wound on an outer circumference of said core body, and
a first spacer inserted into the gap between said first core section and said second core section , and formed of ceramics,
said first spacer including a first retaining member extending towards said coil, and retaining said coil, and
said first retaining member provided so as to form direct contact with said coil.

2. The reactor according to claim 1, wherein said core body further includes a third core section located at a side opposite to said first core section relative to said second core section, and having a gap from said second core section,
said reactor further comprising a second spacer inserted into the gap between said second core section and said third core section, wherein
said second spacer includes a second retaining member extending towards said coil, and retaining said coil,
said coil wound on an outer circumference of said second core section, and sandwiched between said first retaining member and said second retaining member.

3. The reactor according to claim 2, wherein said coil is sandwiched between said first retaining member (and said second retaining member in a compression-deformed state in a direction in which said second core section extends between said first core section and said third core section.

4. The reactor according to claim 1, wherein said first spacer further includes a positioning member extending towards said first core section and said second core section, and regulating a relative position of said first core section and said second core section.

5. The reactor according to claim 1, wherein, on an outer circumference of the gap between said first core section and said second core section, said coil is not arranged, and said first retaining member is arranged.

6. The reactor according to claim 1, wherein said first spacer is formed integrally of a non-magnetic material.

7. The reactor according to claim 1, wherein said core body is formed by a dust core.
